(19) United States
(12) Patent Application Publication
(10) Pub. No.: US 2026/0201634 A1
(43) Pub. Date: Jul. 16, 2026

(54) CARBOXYLATE SALTS OF AMINE COMPOUNDS AS SIZING AGENTS

(71) Applicant: Hexcel Corporation, San Ramon, CA (US)

(72) Inventors: Michael Yurchenko, Decatur, AL (US); Dale Schmidt, Salt Lake City, UT (US); Gary Chang, Salt Lake City, UT (US)

(21) Appl. No.: 19/346,821

(22) Filed: Oct. 1, 2025

Related U.S. Application Data
(60) Provisional application No. 63/743,745, filed on Jan. 10, 2025.

(51) Int. Cl. D06M 13/342; C08G 59/18; C08J 5/06; C08L 63/00; D06M 13/53; D06M 15/55; D06M 15/71; D06M 101/40

(52) U.S. Cl. CPC D06M 13/342; C08G 59/184; C08J 5/06; C08L 63/00; D06M 13/53; D06M 15/55; D06M 15/71; D06M 2101/40; D06M 2200/40

(57) ABSTRACT

Provided are sizing compositions, and more particularly, sizing compositions comprising a carboxylate salt of an amine compound for the treatment of carbon fiber. The structure of the amine used to make the carboxylate salts is RnXmQ, wherein Q is an amine-containing group, X is a polyether group, and R is an aryl or alkyl group, either linear or branched, saturated or unsaturated, or a combination thereof. m and n are integers greater than or equal to 0. The compositions help improve shear strength on carbon fibers in finished goods. Carbon fiber-reinforced composite materials and carbon fibers incorporating said sizing compositions are also provided.

### CROSS-REFERENCE TO RELATED APPLICATION(S)

This application claims the benefit of and priority to U.S. Provisional Application No. 63/743,745, filed on Jan. 10, 2025, which is incorporated by reference herein in its entirety.

### FIELD

The present invention relates generally to sizing compositions, and more particularly, to sizing compositions comprising carboxylate salts of amine compounds.

### BACKGROUND

Carbon fibers have been used in a wide variety of structural applications and industries because of their desirable properties. For example, carbon fibers can be formed into a structural component that combines high strength and high stiffness, while having a weight that is significantly lighter than a metal component of equivalent properties. One common method of preparing carbon fibers involves converting a polyacrylonitrile (PAN) precursor fiber in a multi-step process in which the precursor fiber is heated, oxidized, and carbonized to produce a fiber that is 90% or greater carbon. The resulting carbon fibers can be molded into high strength composite materials for structural applications, used in their pure form for electrical and friction applications, or can be further processed for use in adsorbent, filter, or other applications. In particular, composite materials have been developed in which carbon fibers serve as a reinforcing material in a resin, ceramic, or metal matrix.

At the end of the carbon fiber manufacturing process, a sizing material is typically applied to the carbon fiber. This sizing material, also referred to as sizing or just size, helps to protect the carbon fiber filaments during subsequent handling, weaving, and processing. The sizing may also provide compatibility with the matrix resin used in the process to make the composite material.

In the field of carbon fiber-based composite materials, there is an increasing demand for composite materials having improved mechanical properties. One of such properties is shear strength of laminates. Accordingly, there still exists a need for improved sizing agent compositions which can improve shear properties of carbon fiber-based laminates.

### SUMMARY

It has unexpectedly been found that when amine-containing epoxy cures from the classes of amine-epoxy adducts and amidoamines were neutralized with various acids and with or without additional additives were used as sizing materials at different concentrations on carbon fibers, and the sized fibers then laminated and subjected to Short Beam Shear testing together, an increase in laminate Short Beam Shear strengths was observed and recorded.

An embodiment of the invention is a sizing composition comprising:
0-20% by weight of an epoxy-containing resin, compared to the total weight of the solids in the sizing composition; and
a carboxylate salt of an amine, wherein the amine has the formula

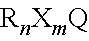

wherein:
Q is an amine-containing group, comprising at least one primary or secondary amine;
X is a polyether group selected from the group consisting of poly (propylene oxide) (PPO) and poly (ethylene oxide) (PEO) or a mix thereof;
m is an integer, where m≥0;
R is an aryl or alkyl group, wherein each alkyl group may be independently linear or branched, and wherein each alkyl group may independently be saturated or unsaturated; R contains from 0-10 heteroatoms; and R is either unsubstituted or substituted with 1-5 substituents selected from the group consisting of C₁-C₁₂ alkyl groups, C₁-C₁₂ heteroalkyl groups, C₆-C₁₄ aryl groups, and C₆-C₁₄ heteroaryl groups; and
n is an integer, with n≥0.

Another embodiment of the invention is a carbon fiber prepared by having a composition as described above dried thereon and, optionally, cured.

Another embodiment of the invention is a method of treating a carbon fiber, comprising applying a sizing composition as described above to a carbon fiber, to form a coating thereon, and then drying, and optionally curing, the coated fiber.

Another embodiment of the invention is a carbon fiber-reinforced composite comprising a carbon fiber as described above.

### DETAILED DESCRIPTION

The present inventions now will be described more fully hereinafter. These inventions may be embodied in many different forms and should not be construed as limited to the embodiments set forth herein; rather, these embodiments are provided so that this disclosure will satisfy applicable legal requirements. Like numbers refer to like elements throughout. As used in the specification, and in the appended claims, the singular forms “a”, “an”, “the”, include plural referents unless the context clearly dictates otherwise. All patents and patent application publications are hereby incorporated by reference in their entireties.

### I. Definitions

For the purposes of the present application, the following terms shall have the following meanings:

The terms “sizing material,” “sizing agent,” “sizing,” and “size” refer to a material applied to a carbon fiber for the purpose of 1) improving the handing, weaving, and/or processing of the carbon fiber and/or 2) improving the compatibility of the carbon fiber with the matrix in a composite material.

The term “fiber” can refer to a fiber of finite length or a filament of infinite length.

The term “precursor fiber” refers to a fiber comprising a polymeric material that can, upon the application of sufficient heat, be converted into a carbon fiber having a carbon content that is about 85% or greater, and in particular about 95% or greater, by weight. The precursor fiber can comprise both homopolymers and copolymers of acrylonitrile (AN), and may include vinyl copolymers such as methyl acrylate (MA), methacrylic acid (MAA), sodium methallylsulfonate, itaconic acid (IA), vinyl bromide (VB), isobutyl methacrylate (IBMA), and combinations thereof. In one embodiment, the precursor fiber comprises a polyacrylonitrile (PAN) polymer formed primarily from acrylonitrile monomers.

The term “solids” in a sizing composition is understood to refer to all components other than a solvent. This includes components which may not actually be in solid form, such as, for example, silicone oil. For example, for an aqueous sizing composition, the weight of the “solids” of the sizing composition may encompass all components other than the weight of the water.

The PAN precursor fibers are typically prepared by melt spinning or by solvating the precursor polymers in organic and/or inorganic solvents such as dimethylsulfoxide, dimethyl formamide, zinc chloride or sodium thiocyanate solutions to form a spinning solution. For example, the spinning solution may be formed from water, acrylonitrile polymer and sodium thiocyanate at exemplary respective weight ratios of about 60:10:30. This solution can then be concentrated through evaporation and filtered to provide the spinning solution. The spinning solution is passed through spinnerets using various spinning processes, such as dry, dry/wet or wet spinning, to form the polyacrylonitrile precursor fiber. After exiting from the spinneret, the spun filaments are washed. In some embodiments, the spun filaments can be stretched up to several times their original length in hot water and steam. After the fibers have been washed, before and/or after the stretching, they are typically subjected to a finishing step, where spin finish is applied to the fibers to protect the fibers in subsequent processing steps.

The terms “about” and “substantially” as used herein means a deviation (plus/minus) of less than 10%, and in particular, less than 5%, less than 4%, less than 3%, and less than 2% of the recited value. It is understood that where a parameter range is provided, all integers and ranges within that range, and tenths and hundredths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 8-10%, 5.1%- 9.9%, and 5.01%- 9.99%. Similarly, where a list is presented, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “carboxylic salt” of an amine refers to a compound created by reacting a carboxylic acid with an amine-containing compound. As used herein, it means that some or all primary and/or secondary amines present have been reacted and converted to their corresponding carboxylate salts.

The term “epoxy-containing resin” refers to any resin made from monomers containing at least one epoxide group. In an embodiment, the epoxy-containing resin is an epoxy resin.

An embodiment of the invention is a sizing composition comprising:
0-20% by weight of an epoxy-containing resin, compared to the total weight of the solids in the sizing composition; and
a carboxylate salt of an amine, wherein the amine has the formula

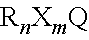

wherein:
Q is an amine-containing group, comprising at least one primary or secondary amine;
X is a polyether group selected from the group consisting of poly (propylene oxide) (PPO) and poly (ethylene oxide) (PEO) or a mix thereof;
m is an integer, where m≥0;
R is an aryl or alkyl group, wherein each alkyl group may be independently linear or branched, and wherein each alkyl group may independently be saturated or unsaturated; R contains from 0-10 heteroatoms; and R is either unsubstituted or substituted with 1-5 substituents selected from the group consisting of C₁-C₁₂ alkyl groups, C₁-C₁₂ heteroalkyl groups, C₆-C₁₄ aryl groups, and C₆-C₁₄ heteroaryl groups; and
n is an integer, with n≥0.

In an embodiment, Q is a monoamine. In an embodiment, Q comprises a plurality of amino groups. In an embodiment, Q comprises a plurality of primary or secondary amino groups. In an embodiment, Q comprises an epoxy-amine adduct.

In an embodiment, X comprises PPO. In an embodiment, X comprises PEO.

In an embodiment, m≥1, m≥2, or m≥3.

In an embodiment, m+n≥0.

In an embodiment, X is absent.

In an embodiment, at least one R is linear. In an embodiment, at least one R is branched.

In an embodiment, at least one R is saturated. In an embodiment, at least one R is unsaturated. In an embodiment, R is unsubstituted. In an embodiment, R is substituted.

In an embodiment, n≥2, or n≥3. In an embodiment, n is 0-20. In an embodiment, n is at least, at most, or about 0, 1, 2, 3, 4, 5, 6, 7, 8, 9, 10, 11, 12, 13, 14, 15, 16, 17, 18, 19, or 20, or within a range defined by any two of these values.

In an embodiment, the carboxylic salt is derived from a monocarboxylic acid. In an embodiment, the carboxylic salt is derived from a polycarboxylic acid. In an embodiment, the carboxylic salt is derived from a polycarboxylic acid derivative with at least one free/unmodified acid group.

An embodiment of the invention is a carbon fiber prepared by having a composition as described above dried and optionally cured on a surface thereof. Following the drying and optional curing, the carboxylate salt may not be present in the coating. An embodiment of the invention is a carbon fiber-reinforced composite comprising a carbon fiber as described above. In an embodiment, the carbon fiber-reinforced composite comprises a resin matrix infused into the fiber.

An embodiment of the invention is a method of preparing a treated carbon fiber, said method comprising the steps of:
i) applying a sizing composition as described above to a carbon fiber, thereby forming a coated carbon fiber; and
ii) drying the coated carbon fiber;
so as to form a treated carbon fiber.

Step i) is generally performed at or about room temperature (approximately 20-25° C.), but this is not a requirement. Step i) is also typically performed by submerging the fiber, or a fabric comprising a plurality of fibers, in a bath comprising the sizing composition. In an embodiment, step i) is performed for about 5 seconds to about 60 seconds. In an embodiment, step i) is performed for at least, at most, or about 5, 10, 15, 20, 25, 30, 35, 40, 45, 50, 55, or 60 seconds, or within a range defined by any two of these values.

In an embodiment, step ii) is performed at a temperature between about 100° C. and about 210° C. In an embodiment, step ii) is performed at a temperature of at least, at most, or about 100, 105, 110, 115, 120, 125, 130, 135, 140, 145, 150, 155, 160, 165, 170, 175, 180, 185, 190, 195, 200, 205, or 210° C., or within a range defined by any two of these values.

In an embodiment, step ii) is performed for about 15 seconds to about 5 minutes. In an embodiment, step ii) is performed for at least, at most, or about 15 seconds, 30 seconds, 45 seconds, 1 minute, 1.5 minutes, 2 minutes, 2.5 minutes, 3 minutes, 3.5 minutes, 4 minutes, 4.5 minutes, or 5 minutes, or within a range defined by any two of these values.

In an embodiment, the method further comprises step iii): curing the coated carbon fiber. In an embodiment, step iii) is performed at a temperature between about 100° C. and about 210° C. In an embodiment, step iii) is performed at a temperature of at least, at most, or about 100, 105, 110, 115, 120, 125, 130, 135, 140, 145, 150, 155, 160, 165, 170, 175, 180, 185, 190, 195, 200, 205, or 210° C., or within a range defined by any two of these values. The term “curing” does not require 100% curing, and encompasses partial curing.

In an embodiment, step iii) is performed for about 15 seconds to about 5 minutes. In an embodiment, step iii) is performed for at least, at most, or about 15 seconds, 30 seconds, 45 seconds, 1 minute, 1.5 minutes, 2 minutes, 2.5 minutes, 3 minutes, 3.5 minutes, 4 minutes, 4.5 minutes, or 5 minutes, or within a range defined by any two of these values.

In an embodiment, step ii) and step iii) are performed concurrently. In an embodiment, step ii) and step iii) are performed consecutively (such as, for example, when the coated fiber is dried at a temperature less than the temperature necessary for curing). When step i) is performed by submerging a carbon fiber or a fabric comprising a plurality of carbon fibers in a bath comprising the sizing solution, the fiber or fabric will be removed from the bath prior to performing step ii) and, if performed, step iii).

### 1. Epoxy Resin

In an embodiment, the epoxy-containing resin is present in the composition in an amount of about 0-20% by weight, compared to the total weight of the solids in the sizing composition. In an embodiment, the epoxy-containing resin is present in the composition in an amount of about 0.01%, about 0.05%, about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight, compared to the total weight of the solids in the sizing composition or within a range defined by any two of these values. In embodiments, the epoxy-containing resin is present in the composition in an amount of 0-15%, 0-10%, 0-5%, 0-2%, 0-1%, 0.01-15%, 0.01-10%, 0.01-5%, 0.01-2%, or 0.01-1% by weight, compared to the total weight of the solids in the sizing composition.

If present, the epoxy resin used in the sizing compositions of the invention may be any epoxide-containing material known in the art. In an embodiment, the epoxy resin is an epoxy-containing copolymer, such as epoxy methacrylate, epoxy acrylate, epoxy ester and siloxane epoxy copolymers. In an embodiment, the epoxy-containing copolymer is an epoxy/urethane copolymer.

Examples of suitable epoxies include those disclosed in U.S. Pat. Nos. 4,409,288 and 6,013,730 and US 2013/0224470, which are hereby incorporated by reference in their entireties. In an embodiment, the epoxy resin is bisphenol-based. In an embodiment, the epoxy resin is bisphenol A-based. In an embodiment, the epoxy resin is bisphenol F-based. In an embodiment, the epoxy resin is bisphenol S-based. In an embodiment, the epoxy resin is a glycidyl amine. In an embodiment, the epoxy resin is a novolak. In an embodiment, the epoxy resin is aliphatic. In an embodiment, the epoxy resin is halogenated.

Specific epoxy resins suitable for use in the present invention include:
Bisphenol A based: EPON 828, EPON 825, EPON 826, EPON 830, EPON 834 (Hexion), DER 332 (Olin Epoxy), Tactix 123 and Tactix 138 (Huntsman).
Bisphenol F based: Araldite GY 281/282/285 (Huntsman) and Rutapox 0158 (Bakelite). Epoxyphenol novolac-based: DEN 431, DEN 428, DEN 439 (Olin Epoxy), EPN 1138 and EPN 1139 (Huntsman).
Glycidyl amines: Araldite MY 9512, Araldite MY 721 and Araldite MY 720 (Huntsman).
Halogenated (brominated): Araldite LT 8049 (Huntsman), DER 542 Olin Epoxy).
Alicyclic epoxies: CY179-1 (Diacel), Araldite 175 (Huntsman) and Epalloy 5000 (Huntsman).

Examples of the compounds having epoxy groups and urethane groups include urethane-modified epoxy resins. Examples include EPU-78-13S, EPU-6, EPU-11, EPU-15, EPU16A, EPU-16N, EPU-17T-6, EPU-1348 and EPU-1395 (Adeka Corporation) and Hydran CF-025 (DIC Corporation).

### 2. Amines

The structure of the amine used to make salts of the invention can be described by the general formula:

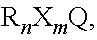

wherein:
Q is an amine-containing group, either having a plurality of amines or a single amino-group. In either case it is important that at least one primary or secondary amine is present. Non-limiting examples include monoamines, polyamines, amidoamines, and polyamidoamines. Q may also be an epoxy-amine adduct. The amine comprises either R or X groups independently or by a combination thereof. Generally, the above formula describes classes of amine-containing compounds used as cures for epoxy resins, known in the art.

X is a polyether group selected from the group consisting of poly (propylene oxide) (PPO) compounds and poly (ethylene oxide) (PEO) compounds, or a mix thereof. In an embodiment, X comprises PPO. In an embodiment, X comprises PEO. In an embodiment, X is a blend of PPO and PEO. In an embodiment, each X comprises 2-50 propylene oxide and/or ethylene oxide monomer units. In an embodiment, each X comprises 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 propylene oxide and/or ethylene oxide monomer units. In an embodiment, each X comprises at least 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 propylene oxide and/or ethylene oxide monomer units. In an embodiment, each X comprises at most 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, or 49 propylene oxide and/or ethylene oxide monomer units.

m is an integer, where m≥0. In an embodiment, m≥1, m≥2, or m≥3. In an embodiment, m is 0, 1, 2, 3, 4, 5, 6, 7, or 8. In an embodiment, m is 0, 1, 2, or 3. In an embodiment, m is 0 or 1. In an embodiment, m is 0. In an embodiment, m is 1. In an embodiment, m is 2. In an embodiment, m is 3.

R is an aryl or alkyl group, either linear or branched, saturated or unsaturated, or a combination thereof. In an embodiment, the aryl group is a C₆-C₁₄ aryl group. In an embodiment, the aryl group is selected from the group consisting of phenyl, benzyl, tolyl, xylyl, and napthyl.

In an embodiment, the alkyl group is a C₁-C₂₄ alkyl group. In an embodiment, the alkyl group is a C₁, C₂, C₃, C₄, C₅, C₆, C₇, C₈, C₉, C₁₀, C₁₂, C₁₂, C₁₃, C₁₄, C₁₅, C₁₆, C₁₇, C₁₈, C₁₉, C₂₀, C₂₁, C₂₂, C₂₃, or C₂₄ alkyl group. In an embodiment, the alkyl group is at least a C₁, C₂, C₃, C₄, C₅, C₆, C₇, C₈, C₉, C₁₀, C₁₂, C₁₂, C₁₃, C₁₄, C₁₅, C₁₆, C₁₇, C₁₈, C₁₉, C₂₀, C₂₁, C₂₂, or C₂₃ alkyl group. In an embodiment, the alkyl group is at most a C₂, C₃, C₄, C₅, C₆, C₇, C₈, C₉, C₁₀, C₁₂, C₁₂, C₁₃, C₁₄, C₁₅, C₁₆, C₁₇, C₁₈, C₁₉, C₂₀, C₂₁, C₂₂, C₂₃, or C₂₄ alkyl group.

R may be substituted with 1-5 substituents each independently selected from the group consisting of C₁-C₁₂ alkyl groups, C₁-C₁₂ heteroalkyl groups, C₆-C₁₄ aryl groups, and C₆-C₁₄ heteroaryl groups. C₁-C₁₂ heteroalkyl groups include, for example, C₁-C₁₂ alkyloxy groups, C₁-C₁₂ alkylamino groups, and C₁-C₁₂ haloalkyl groups.

R can contain 1-10 heteroatoms, in its main chain (i.e., the alkyl or aryl) and/or substituents. A heteroatom is any atom other than C or H. Non-limiting examples of such heteroatoms are N, O, P, and S. R may also contain no heteroatoms. In an embodiment, R contains no more than 5, no more than 4, no more than 3, no more than 2, no more than 1, or 0 heteroatoms.

n is an integer, with n≥0. If n≥2, then each instance of R does not need to be identical to the others. In an embodiment, n≥1, n≥2, or n≥3. In an embodiment, n is 0, 1, 2, 3, 4, 5, 6, 7, or 8. In an embodiment, n is 0, 1, 2, or 3. In an embodiment, n is 0 or 1. In an embodiment, n is 0. In an embodiment, n is 1. In an embodiment, n is 2. In an embodiment, n is 3.

It is understood that when m is 0, X is absent, and that when n is 0, R is absent.

It is also understood that RₙXₘQ is not a structural formula, in that at least one R group may be bound directly to Q, even when X is present.

### 3. Carboxylic Acids

Carboxylic acids used to make such carboxylate amine salts are not limited to any class, and can be, for example, either monocarboxylic or polycarboxylic acids substituted or unsubstituted. Derivatives of polycarboxylic acids can be also used.

In some embodiments, the carboxylic acid is a monocarboxylic acid. Examples of monocarboxylic acids include formic acid, acetic acid, propionic acid, butyric acid, isobutyric acid, valeric acid, isovaleric acid, caproic acid, etc., or a hydroxycarboxylic acid, such as glycolic acid, lactic acid, etc. These monocarboxylic acids may be used either alone or as a mixture of 2 or more thereof.

In one embodiment, the carboxylic acid is a dicarboxylic acid. In an embodiment, the dicarboxylic acid has the following formula:

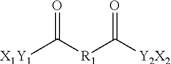

wherein R₁ is absent or a saturated or unsaturated, linear or branched, aromatic, substituted or unsubstituted, hydrocarbon group;
Y₁ and Y₂ are independently a nitrogen, oxygen, sulfur or phosphorus containing group, C₁-C₆ alkyl groups, alkoxy groups, and/or phenyl groups.
X₁ and X₂ are independently a hydrogen, a metal, a quaternary amine, an alcohol, or a hydrocarbon group having up to 6 carbon atoms, the hydrocarbon group being an alkyl group, an alkylene group, or an aromatic group, which may be branched or linear, and may optionally have one or more heteroatoms selected from the group consisting of nitrogen, oxygen, sulfur and phosphorus.

Examples of metals for X₁ and X₂ include alkali metals, such as lithium, potassium, and sodium.

By way of guidance, some examples of possible embodiments of R₁ are provided below in which R₁ is selected from a hydrocarbon having any one or more of the following:
a saturated, linear or branched alkyl chain substituted with one or more of nitrogen, oxygen, sulfur or phosphorus containing groups (examples of such groups include carbonyls, ethers, amides, amines, alcohols, and the like);
an unsaturated, branched or linear alkyl group;
an unsaturated, branched or linear alkyl group substituted with one or more of nitrogen, oxygen, sulfur or phosphorus containing groups, (examples of such groups include carbonyls, ethers, amides, amines, alcohols, and the like);
one or more polyethylene glycol or polypropylene glycol groups;
an aromatic group that is optionally substituted with one or more of an alkyl group, a nitrogen containing group, an oxygen containing group, a sulfur containing group, or a phosphorous containing group (examples of such groups include carbonyls, ethers, amides, amines, alcohols, and the like); and
one or more of an alkene, alkyne, alcohol, carbonyl, ether, amine, amide, phenyl, benzene, furan, pyridine, or pyran group, or imidazole group.

In some embodiments, R₁ may also include combinations of the foregoing exemplary hydrocarbon groups. It should also be recognized that in some embodiments R₁ may be absent.

Examples of dicarboxylic acids that may be used in certain embodiments of the invention include DL-Tartaric acid, L-Tartaric acid, D-Tartaric acid, fumaric acid, mesaconic acid, oxamic acid, succinic acid, 2-methyl succinic acid, L-malic acid, DL-malic acid, D-malic acid, aspartic acid, mesoxalic acid, muconic acid, oxaloacetic acid, glutamic acid, diglycolic acid, iminodiactetic acid, 2,2′-oxydipropanoic acid, 3,3′-oxydipropanoic acid, 2,2′-[1,2-ethanediylbis (oxy)]bis-acetic acid, 3,3′-[1,2-ethanediylbis (oxy)]bis-propanoic acid, 3,3′-[oxybis (ethane-2,1-diyloxy)]dipropanoic acid, poly (ethylene glycol) bis-acetic acid, polyethylene glycol bis (carboxymethyl) ether, polyethylene glycol diacid 600, chelidonic acid, dipicolinic acid, 2,5-furandicarboxylic acid, isophthalic acid, terephtalic acid, orthophthalic acid, trimesic acid, 1,4-phenylene diacetic acid, 1,3-phenylene diacetic acid and their derivatives, such as, ammonium tartrate dibasic, potassium tartrate monobasic, ammonium hydrogenoxalate, monomethyl fumarate, and monoethyl fumarate, and mixtures thereof.

In some embodiments, the dicarboxylic acid may comprise a ketoacid, such as one or more of the following: hydroxypyruvic acid, alpha-ketoglutaric and beta-ketoglutaric, alpha-ketoadipic acid, α-ketovaleric acid, levulinic acid, 4-hydroxy-2-oxopentanoic acid, and 4-hydroxyphenylpyruvic acid.

### 4. Surfactants

The sizing composition may also include a surfactant. The surfactant is not specifically restricted, and can be selected from nonionic, anionic, cationic and amphoteric surfactants known to those skilled in the art. One of or a combination of at least two of such surfactants can be used.

The nonionic surfactants include, for example, linear polyoxyalkylene alkylethers, such as polyoxyethylene hexyl ether, polyoxyethylene octyl ether, polyoxyethylene decyl ether, polyoxyethylene lauryl ether and polyoxyethylene cetyl ether; branched polyoxyalkylene primary alkyl ethers, such as polyoxyethylene 2-ethylhexyl ether, polyoxyethylene isocetyl ether and polyoxyethylene isostearyl ether; branched polyoxyalkylene secondary alkyl ethers, such as polyoxyethylene 1-hexylhexyl ether, polyoxyethylene 1-octylhexyl ether, polyoxyethylene 1-hexyloctyl ether, polyoxyethylene 1-pentylheptyl ether and polyoxyethylene 1-heptylpentyl ether; polyoxyalkylene alkenyl ethers, such as polyoxyethylene oleyl ether; polyoxyalkylene alkylphenyl ethers, such as polyoxyethylene octylphenyl ether, polyoxyethylene nonylphenyl ether, and polyoxyethylene dodecylphenyl ether; polyoxyalkylene alkylarylphenyl ethers, such as polyoxyethylene tribenzyl phenyl, polyoxyethylene dibenzylphenyl ether, and polyoxyethylene benzylphenyl ether; polyoxyalkylene fatty acid esters, such as polyoxyethylene monolaurate, polyoxyethylene monooleate, polyoxyethylene monostearate, polyoxyethylene monomyristylate, polyoxyethylene dilaurate, polyoxyethylene dioleate, polyoxyethylene dimyristylate, and polyoxyethylene distearate; sorbitan esters, such as sorbitan monopalmitate and sorbitan monooleate; polyoxyalkylene sorbitan fatty acid esters, such as polyoxyethylene sorbitan monostearate and polyoxyethylene sorbitan monooleate; glycerin fatty acid esters, such as glycerin monostearate, glycerin monolaurate and glycerin monopalmitate; polyoxyalkylene sorbitol fatty acid esters; sucrose fatty acid esters; polyoxyalkylene castor oil ethers, such as polyoxyethylene castor oil ether; polyoxyalkylene hydrogenated castor oil ethers, such as polyoxyethylene hydrogenated castor oil ether; polyoxyalkylene alkyl aminoethers, such as polyoxyethylene lauryl aminoether and polyoxyethylene stearyl aminoether; oxyethylene-oxypropylene block or random copolymers; terminally alkyletherified oxyethylene-oxypropylene block or random copolymers; and terminally sucrose-etherified oxyethylene-oxypropylene block or random copolymers.

Of those nonionic surfactants, branched polyoxyalkylene primary alkylethers, branched polyoxyalkylene secondary alkylethers, polyoxyalkylene alkenyl ethers, polyoxyalkylene alkylphenyl ethers, polyoxyalkylene fatty acid esters, oxyethylene-oxypropylene block copolymers and terminally alkyletherified oxyethylene-oxypropylene block copolymers are preferable for their excellent performance to emulsify silicone compounds in water. Furthermore, oxyethylene-oxypropylene block or random copolymers and terminally alkyletherified oxyethylene-oxypropylene block copolymers are more preferable for their performance to change into a tarry substance on fiber in baking process so as to protect fiber from damage.

The anionic surfactants include salts of various acids, such as salts of fatty acids, salts of hydroxyl-group-containing carboxylic acids, such as hydroxyacetic acid, potassium hydroxyacetate, lactic acid and potassium lactate; salts of polyoxyalkylene alkylether acetic acids, such as the sodium salt of polyoxyalkylene tridecyl ether acetic acid; salts of carboxyl-polysubstituted aromatic compounds, such as potassium trimellitate and potassium pyromellitate; slats of alkylbenzene sulfonic acids, such as salts of dodecylbenzene sulfonic acid; salts of polyoxyalkylene alkylether sulfonic acids, such as salts of polyoxyethylene 2-ethylhexyl ether sulfonic acids; salts of higher fatty acid amide sulfonic acids, such as salts of stearoyl methyltaurine, salts of lauroyl methyltaurine, salts of myristoyl methyltaurine and salts of palmitoyl methyltaurine; salts of N-acyl sarcosine acids, such as salts of lauroyl sarcosine acid; salts of alkyl phosphonic acids, such as salts of octyl phosphonate, salts of aromatic phosphonic acids, such as the potassium salt of phenyl phosphonate; salts of alkyl phosphonic acid alkyl phosphates, such as salts of 2-ethylhexyl phosphonate mono-2-ethylhexyl ester; salts of nitrogen-containing alkyl phosphonic acids, such as salts of aminoethyl phosphonic acid and its diethanol amine salt; salts of alkyl sulfates, such as salts of 2-ethylhexyl sulfate; salts of polyoxyalkylene sulfates, such as salts of polyoxyethylene 2-ethylhexyl ether sulfate; salts of long-chain sulfosuccinate salts, such as sodium di-2-ethylhexyl sulfosuccinate and sodium dioctyl sulfosuccinate; and long-chain N-acyl glutamates, such as monosodium N-lauroyl glutamate and disodium N-stearoyl-L-glutamate. Anionic surfactants may also include alkyl and aryl phosphoric acids and their derivatives.

The cationic surfactants include, for example, quaternary ammonium salts, such as lauryltrimethyl ammonium chloride and oleylmethylethyl ammonium ethosulfate; and (polyoxyalkylene) alkylaminoether salts, such as (polyoxyethylene) lauryl aminoether lactate salt, stearyl aminoether lactate salt, and (polyoxyethylene) lauryl aminoether trimethyl phosphate salt.

The amphoteric emulsifiers include, for example, imidazoline amphoteric surfactants, such as sodium 2-undecyl-N,N-(hydroxyethyl carboxymethyl)-2-imidazolinate and disodium 2-cocoyl-2-imidazolinium hydroxyde-1-carboxyethyloxiate; betaine amphoteric surfactants, such as 2-heptadecyl-N-carboxymethyl-N-hydroxyethyl imidazolium betaine, lauryldimethyl aminoacetic acid betaine, alkyl betaine, amidobetaine and sulfobetaine; and amino acid amphoteric surfactants, such as N-lauryl glycine, N-lauryl-β-alanine and N-stearyl-β-alanine.

In an embodiment, the surfactant is present in the composition in an amount of about 0.01-20% by weight, compared to the total weight of the solids in the sizing composition. In an embodiment, the surfactant is present in the composition in an amount of about 0.01%, about 0.05%, about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight, compared to the total weight of the solids in the sizing composition or within a range defined by any two of these values.

### 5. Viscosity Modifiers

In some embodiments, the sizing composition may include one or more viscosity modifiers. In general, the viscosity modifier includes any composition that desirably modifies the viscosity without inhibiting the effect of the present invention. Viscosity modifiers may include natural polymers such as starch, cellulose, alginate, agar, carrageenan, collagen, gelatin, guar gum, and xanthan gum. Examples of cellulose polymers may include methyl cellulose, hydroxypropyl methyl cellulose, ethyl cellulose, hydroxyethyl cellulose, and carboxy methyl cellulose. Viscosity modifiers may also include synthetic acrylic-based polymers such as alkali-swellable (or soluble) emulsions (ASE's) hydrophobically modified alkali-swellable emulsions (HASE's) and hydrophobically modified, ethoxylated urethane resins (HEUR's). In some embodiments, the viscosity modifier may comprise an aminocarboxylic material, such as carboxylic acid salts of alkylamines, carboxylic acid salts of arylamines, carboxylic acid salts of alkylarylamines, amino acids and betaine compounds.

In an embodiment, the viscosity modifier is present in the composition in an amount of about 0.01-20% by weight, compared to the total weight of the solids in the sizing composition. In an embodiment, the surfactant is present in the composition in an amount of about 0.01%, about 0.05%, about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by weight, compared to the total weight of the solids in the sizing composition or within a range defined by any two of these values.

### 6. Additional Components

In addition to the above-mentioned components, the sizing composition of the present invention may further contain components so far as those components do not inhibit the effect of the present invention. Those components may include antioxidants, such as phenolic, amine, sulfur, phosphorus or quinone compounds; antistats, such as sulfate salts of higher alcohol or higher alcoholic ethers, sulfonate salts, phosphate salts of higher alcohol or higher alcoholic ethers, lubricants, such as polyethylene glycol, polyvinyl alcohol, alkyl esters of higher alcohol, ethers of higher alcohol, and waxes; antibacterial agents; antiseptics; anticorrosive agents; and hygroscopic agents, and combinations thereof. In some embodiments, the lubricant may comprise a polyethylene glycol with an average molecular weight between 100 and 10,000. More preferrable, the lubricant may comprise a polyethylene glycol with an average molecular weight between 800 and 8000. In a preferred embodiment, the lubricant may comprise a polyethylene glycol with an average molecular weight between 1000 and 2000. In an embodiment, polyethylene glycol is present in the composition in an amount of between 1-40% by weight, compared to the total weight of the solids in the sizing composition.

In an embodiment, each additional component is present in the composition in an amount of about 0.001-40% by weight, compared to the total weight of the solids in the sizing composition. In an embodiment, the additional component is present in the composition in an amount of about 0.01%, about 0.05%, about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, or about 40%, by weight, compared to the total weight of the solids in the sizing composition or within a range defined by any two of these values.

In an embodiment, an additional component may be an ester which does not comprise an epoxy group in the molecule. In an embodiment, the ester is present in an amount of 0.01 to 75%, or 2 to 75% by weight compared to the total weight of the solids in the sizing composition. In an embodiment, the ester is present in an amount of 15 to 50% by weight compared to the total weight of the solids in the sizing composition. The ester may be an aliphatic ester having no aromatic ring or may be an aromatic ester having one or more aromatic rings in the molecule. The ester may have, in addition to the ester group, any functional group such as a hydroxy, an amido group, an imido group, a urethane group, a urea group, a sulfonyl group, a carboxy group, or a sulfo group.

In an embodiment an additional component may be a polyurethane that does not comprise an epoxy group in the molecule.

In an embodiment, the polyurethane is present in an amount of 0.01 to 75%, or 2 to 75% by weight compared to the total weight of the solids in the sizing composition. In an embodiment, the polyurethane is present in an amount of 15 to 50% by weight compared to the total weight of the solids in the sizing composition. Examples of polyurethanes are polyurethanes from Vondic product line (DIC), such as Vondic 1960 NE, Vondic 1970 NE, Vondic 1980 NE and Vondic 8510.

In an embodiment, the carboxylate salt is present in the composition in an amount of about 1% to 100%, by weight, compared to the total weight of the solids in the sizing composition. In an embodiment, the carboxylate salt is present in the composition in an amount of about 10-100%, about 20-100%, about 30-100%, about 40-100%, about 50-100%, about 60-100%, about 70-100%, about 80-100%, about 90-100%, about 50-90%, or about 40-80%, compared to the total weight of the solids in the sizing composition. In an embodiment, the carboxylate salt is present in the composition in an amount of less than, greater than, or about 1%, about 5%, about 10%, about 15%, about 20%, about 25%, about 30%, about 35%, about 40%, about 45%, about 50%, about 55%, about 60%, about 65%, about 70%, about 75%, about 80%, about 85%, about 86%, about 87%, about 88%, about 89%, about 90%, about 91%, about 92%, about 93%, about 94%, about 95%, about 96%, about 97%, about 97.5%, about 98%, about 98.5%, about 99%, about 99.1%, about 99.2%, about 99.3%, about 99.4%, about 99.5%, about 99.6%, about 99.7%, about 99.8%, about 99.9%, about 99.95%, about 99.99%, or 100% by weight, or within a range defined by any two of these values, compared to the total weight of the solids in the sizing composition.

### Discussion

The usage of amine-based curing agents in sizes is known and is described by Vautard in US 2013/0224470 and later. The author there, however, does not teach the use of amine carboxylate salts as inhibited amines present in the sizing for carbon fibers. The un-inhibited amines, the use of which is taught in these documents, are highly reactive even at ambient temperatures and deny options of adding additional epoxy materials (like in Example 7) and having those materials in sizing formulation without reacting to amine-containing entities. Another advantage of using carboxylate salts of amines vs unreacted neat amines is increased water solubility and emulsion stability of the former.

It was discovered that carboxylate salts of certain amine-containing epoxy cures can be used as sizing materials by themselves or in sizing compositions where these materials are the major component of the formulation. This means that such materials exhibited similar properties to those of sizing materials currently used in the field. These properties include: tow protection from breakage during carbon fiber manufacturing and handling, good bundling properties, low to medium friction. Moreover, most importantly discovered was the improvement of shear properties in epoxy resin-based laminates when carbon fibers with such sizes were used vs. fibers with common epoxy sizes lacking such functionalities.

This invention can be used in the field where increased shear strengths of carbon fiber-based laminates (prepregs or weaves) is of importance to the customer or the end-user. Examples of the areas where such articles find use include aerospace and industrial applications.

### Examples

HexTow® AS4C-3K unsized carbon fiber tow with 3,000 filament count, along with IM7-12K and IM10-12K unsized carbon fiber tow with 12,000 filament count (all from Hexcel, Stamford, CT) were used in these studies. ARADUR 340, ARADUR 435 (both amidoamines) and ARADUR 3986 (epoxy-amine adduct) amine-containing curing agents for epoxy resins were obtained from Huntsman (Salt Lake City, UT). CARBOWAXTM SENTRYTM Polyethylene Glycol 1450 was obtained from Dow Chemical (Midland, MI). GP size emulsion (epoxy-based general purpose commercial size emulsion) was obtained from Hexcel. Acetic acid and lactic acid were obtained from Sigma-Aldrich (St. Louis, MO). Epoxy resins type 1 and 2 are each non-toughened epoxy resins. Epoxy resin type 3 is a PES-toughened epoxy resin. Control and stock emulsion preparation

For Control X, where X is the example number, GP emulsion was used.

### Amine Carboxylate Salt Preparation

Generally, amine-containing cures were reacted and completely neutralized with an excess (10% molar) of carboxylic acids in water solution at 60° C. for 2 hrs. Stoichiometry was calculated either from known structures and molecular weights or from amine values of cures reported by suppliers when exact structure was not known. pH of the resulting mixture was measured to make sure it was below 7.

### Sizing Application and Drying

All sizing emulsions/solutions were applied to the tow from the sizing bath at either 0.5, 1 or 2 wt. % concentration and dried at various temperatures either via a non-contact drying (drying tower) or contact drying (steam drums), or both.

### Short Beam Shear (SBS) Testing

Various laminate panels were prepared to evaluate the interlaminar strength of fiber reinforced composites using SBS accordance with ASTM D 2344. Sample widths were 0.25+0.005 inches. 4:1 span to depth ratio was used. Nine replicates were tested per each sample.

The epoxy infused laminates had a basis weight of 145 g/m², and were prepared by laying down 16 plies of the carbon fibers. The carbon fibers were laid down by hand or with a tension stand. All plies had 0° orientation and were laid onto epoxy tapes. Three epoxy resins Type 1, Type 2 and Type 3 were used. The panels were then cut and pressed to form a prepreg. Carbon fiber lengths were approximately 30 meters.

The epoxy infused laminate panels were cured in an autoclave using two cycles:
1) cure cycle: the laminate panels were heated to 240° F., which was held for a duration of 65 minutes at a pressure of 85 PSI. The panels were then heated to 350° F., and held for a duration of 120 minutes at a pressure of 100 PSI. The panels were then cooled to 140° F. at a rate of 3° F. per minute.
2) post cure cycle: The panels were then heated to 350° F., which was held for a duration of 4 hours. The panels were then cooled down to 140° F.

### Controls X

These emulsions did not contain the amine-carboxylate curing agents. They were applied to a carbon fiber tow from 1 wt. % concentration and dried via non-contact drying (drying tower) or contact drying (steam drum) or both.

### Example 1

ARADUR 3986 was neutralized with acetic acid and diluted with water to 1 wt. % solids to make a sizing solution. Emulsion was applied to AS4C-3K carbon fiber tow from 1 wt. % concentration and dried via non-contact drying (drying tower) at 125° C. Same feed fiber was sized with GP emulsion at 1 wt. % in the same experiment using the same conditions and designated Control 1-1. Both fibers were tested for SBS strength in laminates in resin Type 1. Results are reported in Table 1 below.

### Example 2

ARADUR 3986 was neutralized with acetic acid and diluted with water to 1 wt. % solids to make a sizing solution. Emulsion was applied to AS4C-3K carbon fiber tow from 1 wt. % concentration and dried via non-contact drying (drying tower) at 125° C. Same feed fiber was sized with GP emulsion at 1 wt. % in the same experiment using the same conditions and designated Control 1-2. Both fibers were tested for SBS strength in laminates in resin Type 2. Results are reported in Table 1 below.

### Example 3

ARADUR 3986 was neutralized with acetic acid and diluted with water to 1 wt. % solids to make a sizing solution. Emulsion was applied to IM7-12K carbon fiber tow from 0.5 wt. % concentration and dried via contact drying (steam drum) at 130° C. Same feed fiber was sized with GP emulsion at 1 wt. % in the same experiment using the same conditions and designated Control 1-3. Both fibers were tested for SBS strength in laminates in resin Type 2. Results are reported in Table 1 below.

### Example 4

ARADUR 3986 was neutralized with acetic acid and diluted with water to 1 wt. % solids to make a sizing solution. Emulsion was applied to IM10-12K carbon fiber tow from 1 wt. % concentration and dried via contact drying (steam drum) at 130° C. Same feed fiber was sized with GP emulsion at 1 wt. % in the same experiment using the same conditions and designated Control 1-4. Both fibers were tested for SBS strength in laminates in resin Type 3. Results are reported in Table 1 below.

Examples 5-7 were run in the same trial with the same feed fiber, therefore, Controls 5, 6 and 7 are the same control.

### Example 5

ARADUR 3986 was neutralized with lactic acid and diluted with water to 1 wt. % solids to make a sizing solution. Emulsion was applied to AS4C-3K carbon fiber tow from 1 wt. % concentration and dried via non-contact drying (drying tower) at 125° C. Same feed fiber was sized with GP emulsion at 1 wt. % in the same experiment using the same conditions and designated Control 5. Both fibers were tested for SBS strength in laminates in resin Type 2. Results are reported in Table 1 below.

### Example 6

ARADUR 3986 was neutralized with lactic acid and diluted with water to 2 wt. % solids to make a sizing solution. Emulsion was applied to AS4C-3K carbon fiber tow from 2 wt. % concentration and dried via non-contact drying (drying tower) at 125° C. Same feed fiber was sized with GP emulsion at 1 wt. % in the same experiment using the same conditions and designated Control 6. Both fibers were tested for SBS strength in laminates in resin Type 2. Results are reported in Table 1 below.

### Example 7

ARADUR 3986 was neutralized with lactic acid. It was mixed with GP epoxy size in a ratio that resulted in 10 wt. % content of neat epoxy from the GP size in the mix. This mix was diluted with water to 1 wt % to make a sizing solution. Emulsion was applied to a AS4C-3K carbon fiber tow from 1 wt. % concentration and dried via non-contact drying (drying tower) at 125° C. Same feed fiber was sized with GP emulsion at 1 wt. % in the same experiment using the same conditions and designated Control 7. Both fibers were tested for SBS strength in laminates in resin Type 2. Results are reported in Table 1 below.

Examples 8-11 were run in the same trial, with the same feed fiber, therefore, Controls 8, 9, 10, and 11 are the same control.

### Example 8

ARADUR 435 was neutralized with acetic acid and diluted with water to 1 wt. % solids to make a sizing solution. Emulsion was applied to AS4C-3K carbon fiber tow from 1 wt. % concentration and dried via non-contact drying (drying tower) at 140° C. Same feed fiber was sized with GP emulsion at 1 wt. % in the same experiment using the same conditions and designated Control 8. Both fibers were tested for SBS strength in laminates in resin Type 2. Results are reported in Table 1 below.

### Example 9

ARADUR 435 was neutralized with acetic acid and diluted with water to 0.5 wt. % solids to make a sizing solution. Emulsion was applied to AS4C-3K carbon fiber tow from 0.5 wt. % concentration and dried via non-contact drying (drying tower) at 140° C. Same feed fiber was sized with GP emulsion at 1 wt. % in the same experiment using the same conditions and designated Control 9. Both fibers were tested for SBS strength in laminates in resin Type 2. Results are reported in Table 1 below.

### Example 10

ARADUR 340 was neutralized with acetic acid and diluted with water to 1 wt. % solids to make a sizing solution. Emulsion was applied to AS4C-3K carbon fiber tow from 1 wt. % concentration and dried via non-contact drying (drying tower) at 140° C. Same feed fiber was sized with GP emulsion at 1 wt. % in the same experiment using the same conditions and designated Control 10. Both fibers were tested for SBS strength in laminates in resin Type 2. Results are reported in Table 1 below.

### Example 11

ARADUR 340 was neutralized with acetic acid and diluted with water to 0.5 wt. % solids to make a sizing solution. Emulsion was applied to AS4C-3K carbon fiber tow from 0.5 wt. % concentration and dried via non-contact drying (drying tower) at 140° C. Same feed fiber was sized with GP emulsion at 1 wt. % in the same experiment using the same conditions and designated Control 11. Both fibers were tested for SBS strength in laminates in resin Type 2. Results are reported in Table 1 below.

TABLE 1
SBS testing results for laminates prepared from fibers with different
carboxylate salt of amine cures

| | | | Drying | | | SBS |
|---|---|---|---|---|---|---|
| | Amine | Carboxylic | temp. | Fiber | Matrix | strength |
| | cure | acid | (C. °) | Type | Resin Type | (ksi) |
| Example 1 | ARADUR | acetic | 125 | AS4C-3K | 1 | 19.92 |
| | 3986 | | | | | |
| Control 1 | — | — | 125 | AS4C-3K | 1 | 18.70 |
| Example 2 | ARADUR | acetic | 125 | AS4C-3K | 2 | 19.93 |
| | 3986 | | | | | |
| Control 2 | — | — | 125 | AS4C-3K | 2 | 19.09 |
| Example 3 | ARADUR | acetic | 130 | IM7-12K | 2 | 20.06 |
| | 3986 | | | | | |
| Control 3 | — | — | 130 | IM7-12K | 2 | 19.68 |
| Example 4 | ARADUR | acetic | 130 | IM10-12K | 3 | 14.88 |
| | 3986 | | | | | |
| Control 4 | — | — | 130 | IM10-12K | 3 | 14.19 |
| Example 5 | ARADUR | lactic | 125 | AS4C-3K | 2 | 18.97 |
| | 3986 | | | | | |
| Control 5 | — | — | 125 | AS4C-3K | 2 | 16.76 |
| Example 6 | ARADUR | lactic | 125 | AS4C-3K | 2 | 19.00 |
| | 3986 | | | | | |
| Control 6 | — | — | 125 | AS4C-3K | 2 | 16.76 |
| Example 7 | ARADUR | lactic | 125 | AS4C-3K | 2 | 18.70 |
| | 3986 | | | | | |
| Control 7 | — | — | 125 | AS4C-3K | 2 | 16.76 |
| Example 8 | ARADUR | acetic | 140 | AS4C-3K | 2 | 17.91 |
| | 435 | | | | | |
| Control 8 | — | — | 140 | AS4C-3K | 2 | 17.71 |
| Example 9 | ARADUR | acetic | 140 | AS4C-3K | 2 | 18.23 |
| | 435 | | | | | |
| Control 9 | — | — | 140 | AS4C-3K | 2 | 17.71 |
| Example 10 | ARADUR | acetic | 140 | AS4C-3K | 2 | 18.18 |
| | 340 | | | | | |
| Control 10 | — | — | 140 | AS4C-3K | 2 | 17.71 |
| Example 11 | ARADUR | acetic | 140 | AS4C-3K | 2 | 17.94 |
| | 340 | | | | | |
| Control 11 | — | — | 140 | AS4C-3K | 2 | 17.71 |

It can be seen that using carboxylate salts of amine compounds as sizes on a variety of carbon fibers increases Short Beam Shear strengths of epoxy-based laminates based on these fibers.

Many modifications and other embodiments of the inventions set forth herein will come to mind to one skilled in the art to which the inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

Although specific terms are employed herein, they are used in a generic and descriptive sense only and not for purposes of limitation. Each embodiment disclosed herein is contemplated as being applicable to each of the other disclosed embodiments. All combinations and sub-combinations of the various elements described herein are within the scope of the embodiments.

1. A sizing composition comprising:
a) 0-20% by weight of an epoxy-containing resin, compared to the total weight of the solids in the sizing composition; and
b) a carboxylate salt of an amine, wherein the amine has the formula 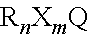
wherein:
Q is an amine-containing group, comprising at least one primary or secondary amine;
X is a polyether group selected from the group consisting of poly (propylene oxide) (PPO) compounds and poly (ethylene oxide) (PEO) compounds or a mix thereof;
m is an integer, where m≥0;
R is an aryl or alkyl group, wherein each alkyl group may be independently linear or branched, and wherein each alkyl group may independently be saturated or unsaturated; R contains from 0-10 heteroatoms; and R is either unsubstituted or substituted with 1-5 substituents selected from the group consisting of C₁-C₁₂ alkyl groups, C₁-C₁₂ heteroalkyl groups, C₆-C₁₄ aryl groups, and C₆-C₁₄ heteroaryl groups; and
n is an integer, with n≥0.

2. The composition of claim 1, wherein Q is a monoamine.

3. The composition of claim 1, wherein Q comprises a plurality of amino groups.

4. (canceled)

5. The composition of claim 1, wherein Q comprises a polyamidoamine or an epoxy-amine adduct.

6.-8. (canceled)

9. The composition of claim 1, wherein m≥1, m≥2, or m≥3.

10. The composition of claim 1, wherein X is absent.

11. The composition of claim 1, wherein at least one R is linear or branched.

12. (canceled)

13. The composition of claim 1, wherein at least one R is saturated.

14. The composition of claim 1, wherein at least one R is unsaturated.

15. The composition of claim 1, wherein R is unsubstituted.

16. (canceled)

17. The composition of claim 1, wherein n≥2, or n≥3.

18. The composition of claim 1, wherein the carboxylic salt is derived from a monocarboxylic acid.

19. The composition of claim 1, wherein the carboxylic salt is derived from a polycarboxylic acid.

20. (canceled)

21. The composition of claim 1, wherein the composition does not comprise any epoxy-containing resin.

22. The composition of claim 1, further comprising a surfactant, a viscosity modifier, an ester which does not comprise an epoxy group, or a polyurethane which does not comprise an epoxy group.

23.-29. (canceled)

30. The composition of claim 1, further comprising an additional component selected from the group consisting of antioxidants, antistats, lubricants, antibacterial agents, antiseptics, anticorrosive agents, and hygroscopic agents, and combinations thereof.

31. (canceled)

32. A carbon fiber prepared by having a composition according to claim 1 dried on a surface thereof.

33. (canceled)

34. A carbon fiber-reinforced composite comprising the carbon fiber of claim 32.

35. (canceled)

36. A method of preparing a treated carbon fiber, said method comprising the steps of:
i) applying a composition as described in claim 1 to a carbon fiber, thereby forming a coated carbon fiber; and
ii) drying the coated carbon fiber;
so as to form a treated carbon fiber.

37.-39. (canceled)

40. The method of claim 36, further comprising:
iii) curing the coated fiber.

41.-44. (canceled)
